(19) United States
(12) Patent Application Publication
(10) Pub. No.: US 2018/0046523 A1
(43) Pub. Date: Feb. 15, 2018

(54) ANALYSIS OF EVENT DRIVEN APPLICATION VIA SYMBOLIC DYNAMIC PARTIAL ORDER REDUCTION

(71) Applicant: FUJITSU LIMITED, Kawasaki-shi (JP)

(72) Inventor: Peng LI, Milpitas, CA (US)

(73) Assignee: FUJITSU LIMITED, Kawasaki-shi (JP)

(21) Appl. No.: 15/236,254

(22) Filed: Aug. 12, 2016

(51) Int. Cl. G06F 9/54; G06F 11/30; G06F 11/34

(52) U.S. Cl. CPC G06F 9/542; G06F 11/3409; G06F 11/302

(57) ABSTRACT

A device for analyzing an event driven application may be provided. The device may include one or more processors. The one or more processors may be configured to execute, in a symbolic environment, an event of an enabled event set. Further, the one or more processors may be configured to update a persistent set and a visited event of the enabled event set via symbolic dynamic partial order reduction. The one or more processors may also be configured to discard each path constraint and event pair being read-write independent.

### FIELD

The embodiments discussed herein are related to symbolic dynamic partial order reduction for analysis of event driven applications.

### BACKGROUND

Event-driven applications, such as web applications and mobile applications, respond to events (e.g., significant, identifiable occurrences for system hardware or software), such as user-generated actions (e.g., mouse clicks, keystrokes, etc.) and system-generated actions (e.g., program loading).

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a device includes one or more processors. The one or more processors may be configured to execute, in a symbolic environment, an event of one or more events of an enabled event set. Further, the one or more processors may be configured to update a persistent set and a visited event of the event set via symbolic dynamic partial order reduction. The one or more processors may also be configured to discard each path constraint and event pair being read-write independent.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A is a screenshot of a user interface for an event driven application;

FIG. 1B depicts example code for a function for adding a product into a product table and increasing a number of products by one;

FIG. 2A is another screenshot of a user interface for an event driven application;

FIG. 2B depicts example code for a function for removing all products from a product table and setting a number of products equal to zero;

FIG. 3A illustrates an example execution scenario including two paths;

FIG. 3B illustrates another example execution scenario including two paths;

FIG. 3C illustrates yet another example execution scenario including two paths;

FIG. 4A depicts a trace of an event sequence;

FIG. 4B depicts visited and unvisited events of the trace of FIG. 4A;

FIG. 4C depicts an unexplored event of the trace of FIG. 4A;

FIG. 4D depicts a new, extended trace of an event sequence;

FIGS. 5A and 5B depict a flowchart of an example method of analyzing an event driven application; and

FIG. 6 is a block diagram of an example computing device.

### DESCRIPTION OF EMBODIMENTS

The embodiments discussed herein are related to analyzing event driven applications. More specifically, embodiments discussed herein relate to analyzing event driven applications via a symbolic-based dynamic partial order reduction.

Event driven applications (e.g., web applications and mobile applications) are prevalent. However, these applications are difficult to test, debug and root-cause any defects due to the widely recognized state space explosion. To effectively test an event driven application, reducing the event sequence space while not compromising analysis precision is critical. Amongst many optimization mechanisms, dynamic partial order reduction (DPOR) is considered as an effective methodology to reduce the state space blow-up. DPOR is typically used in the domain of model checking of imperative programs testing and verification as well as concurrent software testing.

Recently, stateless model checking of event driven applications based on DPOR has been used to test realistic web applications. Although DPOR may be capable of improving analysis scalability, conventional methods are applied in a concrete scenario thus decreasing analysis accuracy.

Various embodiments described herein may utilize symbolic-based dynamic partial order reduction (e.g., a combination of symbolic execution and dynamic partial order reduction), which may improve the accuracy of the analysis of event driven applications while not compromising the scalability.

Embodiments of the present invention will be explained with reference to the accompanying drawings.

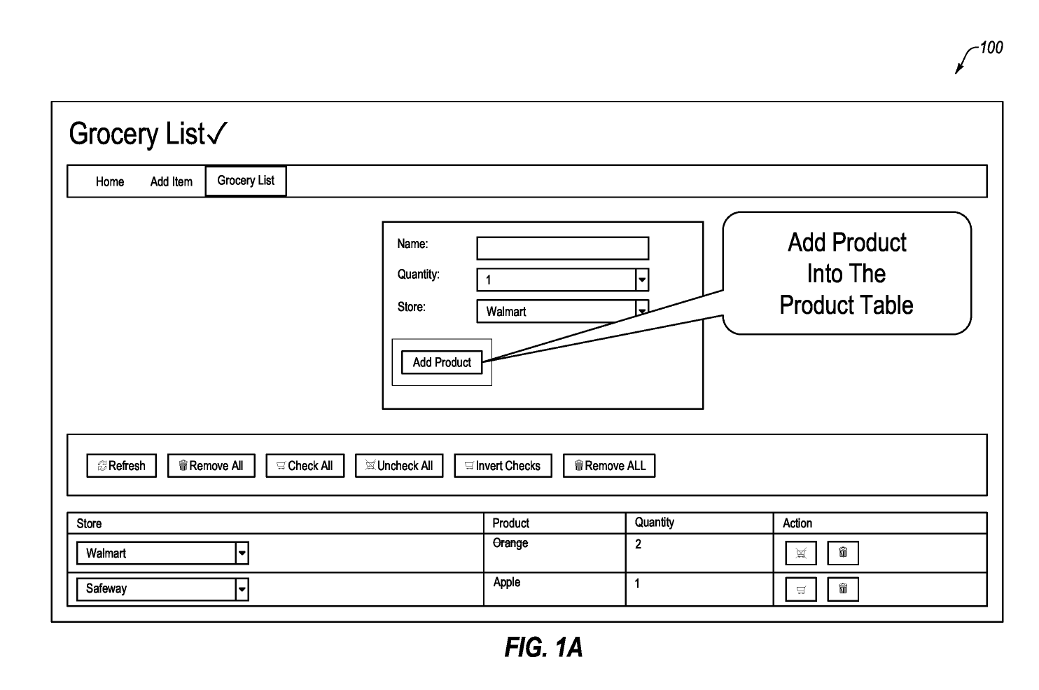

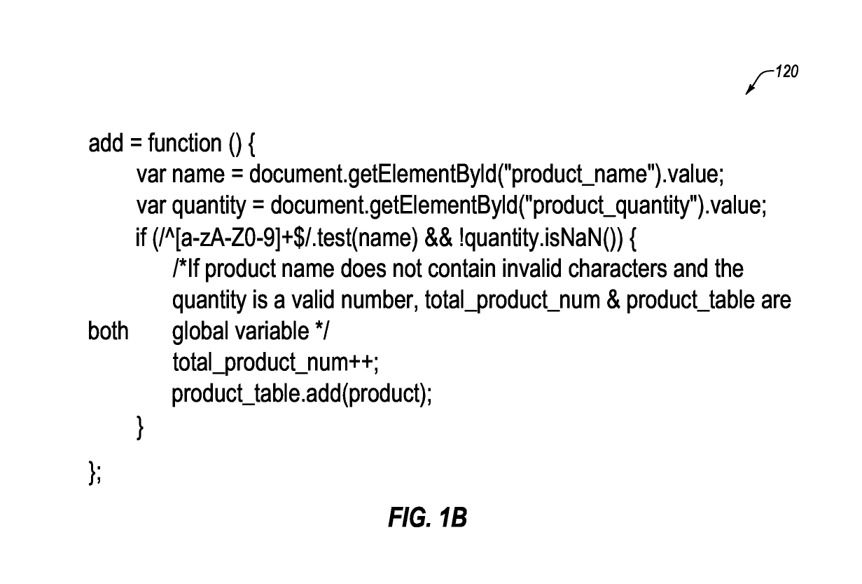

FIG. 1A is a screenshot 100 of a user interface of an event driven application. As illustrated in FIG. 1A, the application is configured to add a product (e.g., a grocery product) to a product table. A user may designate a name of the product, a quantity, and a store. Further, the user may add the product into the product table by selecting an “Add Product” tab.

FIG. 1B depicts example code 120 for a function for adding a product into a product table. As shown in FIG. 1B, if a provided name for a product is valid (e.g., does not include invalid characters) and the provided quantity is a valid (e.g., includes a valid number), a number of total products (“total_product_num”) may be increased by one and the product may be added to the product table.

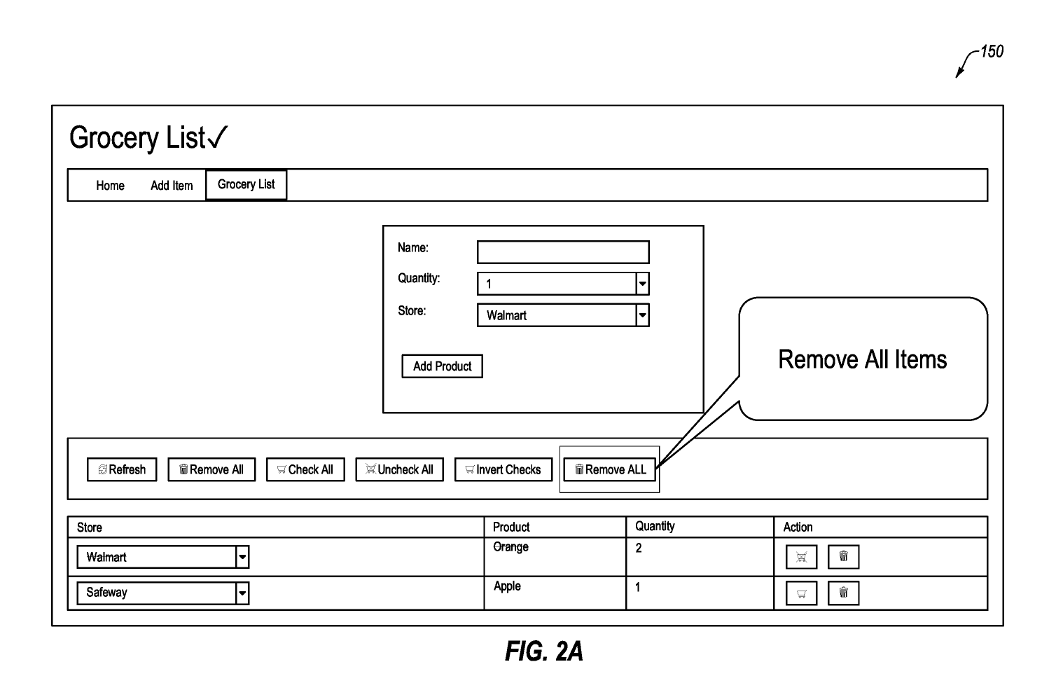

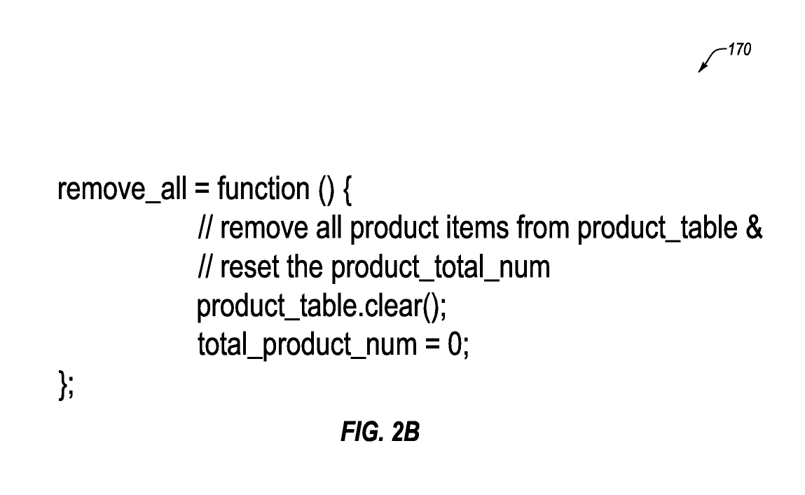

FIG. 2A is another screenshot 150 of a user interface of the event driven application. As illustrated in FIG. 2A, the application is configured to remove all product items (e.g., all grocery products) from the product table. FIG. 2B depicts example code 170 for a function for removing all product items from the product table and setting a number of products equal to zero.

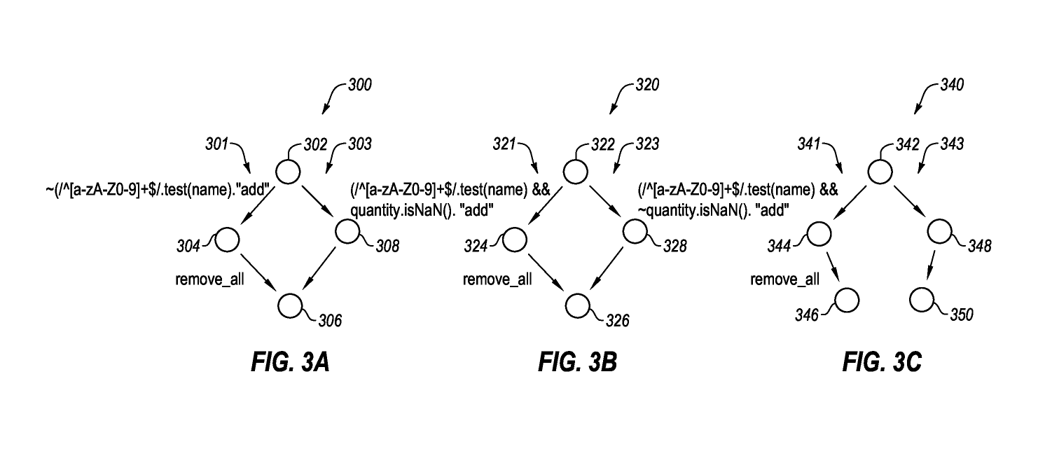

FIG. 3A illustrates an example execution scenario 300 including a path 301 including points 302, 304 and 306 and another path 303 including points 302, 308, and 306. In path 301, at point 302, the function for adding a product to a product table may be called. However, in this example, the name of the product to be added to the product table is invalid (e.g., includes invalid characters) and scenario proceeds to point 304. Further, at point 304, the function for removing all product items from the product table is called, and scenario proceeds to point 306.

In path 303, at point 302, the function for removing all product items from the product table is called, and scenario proceeds to point 308. Further, at point 308, the function for adding a product to a product table may be called. However, the name of the product to be added to the product table is invalid (e.g., includes invalid characters) and scenario proceeds to point 306.

FIG. 3B illustrates an example execution scenario 320 including a path 321 including points 322, 324 and 326 and another path 323 including points 322, 328, and 326. In path 321, at point 322, the function for adding a product to a product table may be called. However, the provided quantity is invalid (e.g., not a valid number) and scenario proceeds to point 324. Further, at point 324, the function for removing all product items from the product table is called, and scenario proceeds to point 326.

In path 323, at point 322, the function for removing all product items from the product table is called, and scenario proceeds to point 328. Further, at point 328, the function for adding a product to a product table may be called. However, the provided quantity is invalid (e.g., not a valid number) and scenario proceeds to point 326.

Scenarios 300 and 320 are each redundant. More specifically, for scenario 300 (FIG. 1A), paths 301 and 303 each end at point 306, thus exploring only one of the two paths is sufficient. Similarly, for scenario 320 (FIG. 1B), paths 321 and 323 each end at point 326, thus exploring only one of the two paths is sufficient. Each of scenario 300 and scenario 320 may undesirably result in state space blow-up.

FIG. 3C illustrates an example execution scenario 340 including a path 341 including points 342, 344 and 346 and another path 343 including points 342, 348, and 350. In path 341, at point 342, the function for adding a product to a product table may be called. In this scenario, both the name of the product to be added to the product table and the quantity are valid and scenario proceeds to point 344. Further, at point 344, the function for removing all product items from the product table is called, and scenario proceeds to point 346.

In path 343, at point 342, the function for removing all product items from the product table is called, and scenario proceeds to point 348. Further, at point 348, the function for adding a product to a product table may be called. Further, because both the name of the product to be added to the product table and the quantity are valid, scenario proceeds to point 350. As illustrated, paths 341 and 343 end at different points.

With regard to partial order reduction (POR), events (e.g., events X and Y) are independent if the events do not affect each other in any executable event sequence. Stated another way, if the events (e.g., events X and Y) do not enable or disable each other and the events are commutative, the events are independent.

Further, a relationship I is a read-write independent relationship if for any (X, Y) ∈ I and for any trace, there is no shared location written by one of the two events, and read or written by the other. The events (e.g., events X and Y) conflict if they are both enabled and dependent (not read/write independent).

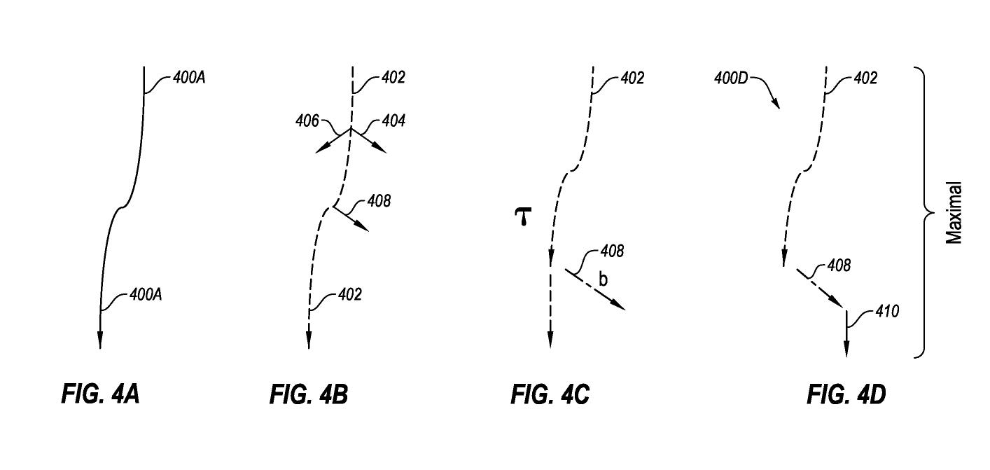

Dynamic partial order reduction may be used to identify a dependence relationship amongst events at run time. For example, FIG. 4A depicts a trace 400A of an event sequence. FIG. 4B depicts trace τ including visited event 402 and unvisited events 404, 406, and 408. According to one embodiment, a persistent set, which may include a subset of the enabled events set, and visited transitions for each state may be updated. A persistent set may include events that disable or enable each other and are read-write dependent.

Further, trace τ may be reduced until its final state has an unexplored event. Stated another way, a process may include backtracking until an unexplored event 408 (see FIG. 4C) is found (e.g., backtracking until the first unexplored event is found). Further, as illustrated in FIG. 4D, a new trace 400D may be explored (extending τ and event 408 maximally).

Read-write dependency analysis in a concrete scenario may too aggressive and also may be incomplete. In one example, if “name”:=“@@@” or “quantity”:=“test”, an “add” event with the above inputs and a “remove_all” event are incorrectly justified as independent in a concrete environment. An “add” event and “remove_all” event are dependent if, for example, “name”==“kiwi” and “quantity”==“10”.

In a symbolic environment, execution may include utilizing symbolic values for inputs rather than obtaining actual inputs as used during concrete execution. In one example of a concrete environment, “name” and “quantity” are set with invalid concrete values (e.g., name==“a@b” && quantity==“1&4”), and, therefore, only one concrete path may be executed. In one example of a symbolic environment, “name” and “quantity” may be treated as unknown variables, and a plurality of paths (e.g., three paths in this example) in an “add” event may be explored with a corresponding path constraint. In this example, three states may correspond to the three paths.

For example, for a regular expression constraint “!(/̂[a-zA-Z0-9]+$/.test(name))”, if “name” does not match a regular expression, in this scenario, the add event is independent with the remove_all event. For example, Name==“@@@” or other values satisfying the regular expression constraint “!(/̂[a-zA-Z0-9]+$/.test(name)” may be determined later (e.g., via an SMT solver).

Further, for a regular expression constraint “(/̂[a-zA-Z0-9]+$/.test(name)&& quantity.isNaN( )”, if “name” matches the regular expression but the “quantity” is not a valid number, add event may be independent with the remove_all event.

In addition, for a regular expression constraint “(/̂[a-zA-Z0-9]+$/.test(name) &&!quantity.isNaN( )”, if “name” matches the regular expression and the “quantity” is a valid number, the add event is dependent with the remove_all event since those the events operate on shared variables.

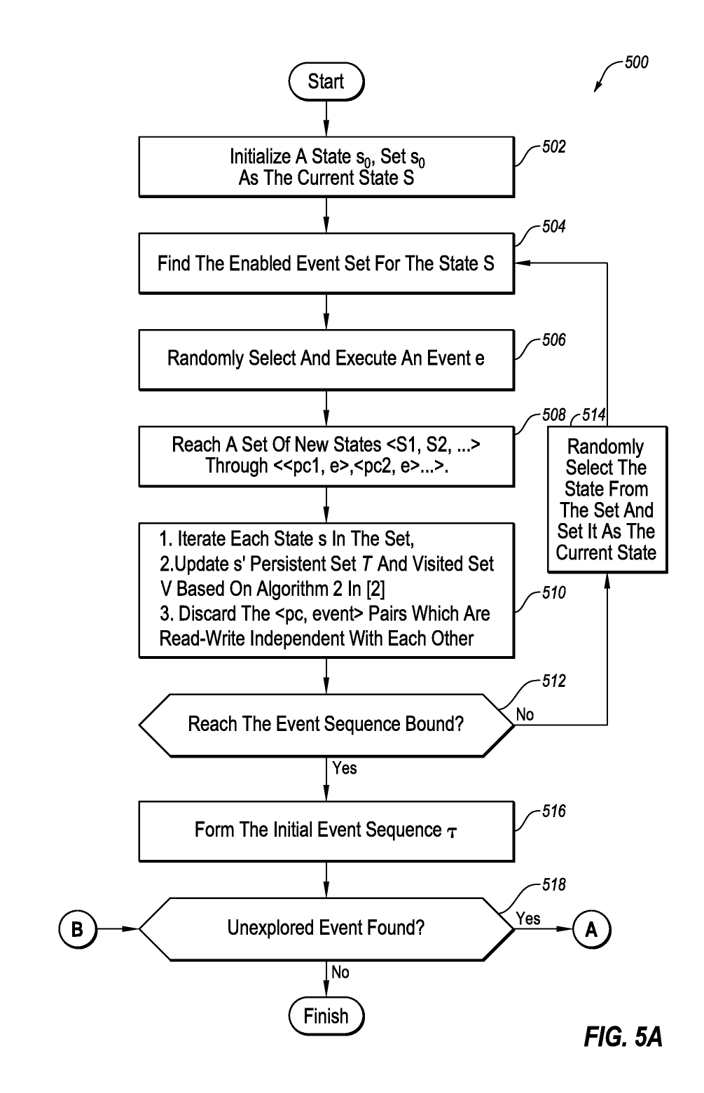

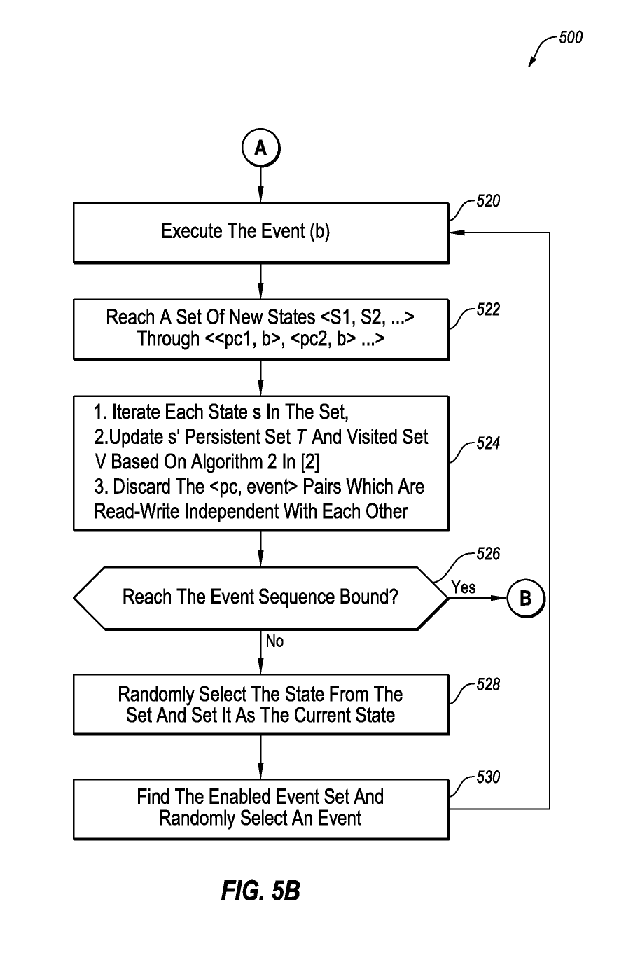

FIGS. 5A and 5B depict a flowchart of a method 500 of analyzing an event driven application, arranged in accordance with at least one embodiment described herein. Although illustrated as discrete blocks, various blocks may be divided into additional blocks, combined into fewer blocks, or eliminated, depending on the desired implementation.

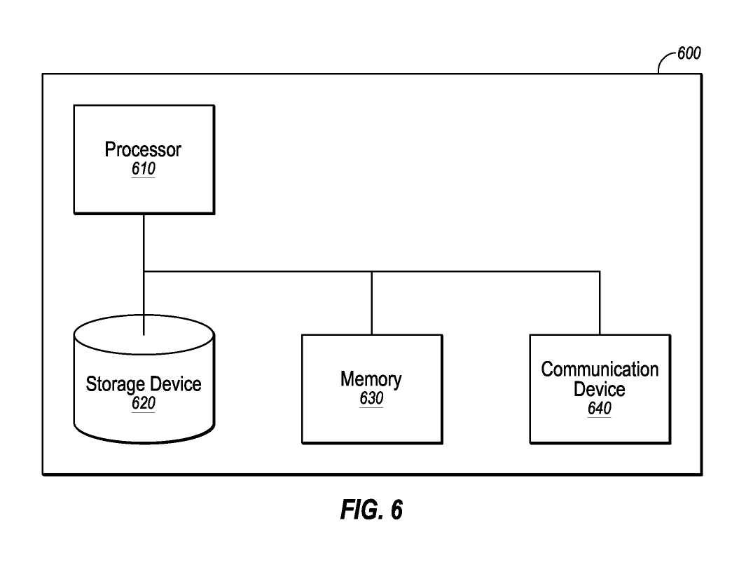

In some embodiments, method 500 may be performed by a system or device, such as computing device 600 of FIG. 6. For instance, processor 610 of computing device 600 (see FIG. 6) may be configured to execute computer instructions stored on memory 630 to perform functions and operations as represented by one or more of the blocks of method 500.

Method 500 may begin at block 502. At block 502, a state may be initialized and set as a current state, and method 500 may proceed to block 504. At block 504, an enabled event set for the current state may be determined, and method 500 may proceed to block 506. At block 506, an event (e.g., event e) may be randomly selected and executed, and method may proceed to block 508. For example, the event may be executed via symbolic execution.

At block 508, a set of new states (e.g., <S1, S2, . . . >) based on path constraint and event pairs (e.g., <pc1, e>, <pc2, e>, . . . ) may be generated, and method 500 may proceed to block 510. For example, a set of new states may be generated in response to execution of the event at block 506.

At block 510, in a symbolic environment, each state in the set may be iterated, a persistent set and a visited set may be updated (e.g., via symbolic dynamic partial order reduction), and path constraint and event pairs (e.g., <pc1, e>, <pc2, e>, etc.), which are read-write independent, may be discarded, and method 500 may proceed to block 512. For example, the persistent set and the visited set may be updated based on the following process. The persistent set may be updated by comparing events that have already been executed in an event sequence. Thus, a function to update a persistent set may operate on a trace τ after receiving the trace either as an initial trace or from a replay. However, it is noted that a persistent set may be incrementally built from all executions explored to a point and not only from the last execution.

The process may iterate over each event τᵢ in the trace τ, updating the persistent set for the prefix τ^{p} of τᵢ. The process may build the persistent set T(τₚ) from the events that conflict with event τᵢ. Event τᵢ may be extended by checking for two kinds of conflicts: conflicts caused by events being disabled; and conflicts caused by non-commuting events.

In one embodiment, an event e may be disabled by event τᵢ and thus event e must be explored before event τᵢ. In another embodiment a linearization may exist such that two events τᵢ and τⱼ may be made adjacent and conflicting by reordering the events after τᵢ into appropriate sequences λ and μ. Determining the existence of such a linearization where events τᵢ and τⱼ are adjacent may be accomplished via determining there is no k between i and j where τᵢ→τₖ and τₖ→τⱼ. Intuitively, these are requirements that may allow for the order of the two conflicting events τᵢ and τⱼ to be reversed. If λ is the empty sequence, a conflict may indicate that event τⱼ is enabled at τ^{p} and thus event τⱼ may be added to the persistent set. If λ is not empty and λ₁→τ τⱼ, λ₁ may be added to the persistent set since it makes a step toward a state where event τⱼ may be executed before event λᵢ.

At block 512, a determination may be made as to whether an event sequence bound of the enabled event set has been reached. If it is determined that the event sequence bound has been reached, method 500 may proceed to block 516. If it is determined that the event sequence bound has not been reached, method 500 may proceed to block 514.

At block 514, a state from the event set may be randomly selected and set as the current state, and method 500 may return to block 504.

At block 516, an initial event sequence τ may be formed, and method 500 may proceed to block 518.

At block 514, a determination may be made as to whether an unexplored event is found (e.g., via backtracking). More specifically, for example, a first unexplored event may be found (e.g., via backtracking). If it is determined that an unexplored event is not found, method 500 may finish. If it is determined that an unexplored event is found, method 500 may proceed to block 520.

At block 520, the event b, found at block 514 or block 530, may be executed, method 500 may proceed to block 522. For example, the event may be executed via symbolic execution.

At block 522, a set of new states (e.g., <S1, S2, . . . >) based on path constraint and event pairs (e.g., <pc1, b>, <pc2, b>, . . . ) may be generated, and method 500 may proceed to block 524. For example, a set of new states may be generated in response to execution of the event b at block 520.

At block 524, in a symbolic environment, each state in the event set may be iterated, a persistent set and a visited set may be updated(e.g., via symbolic dynamic partial order reduction), and path constraint and event pairs (e.g., <pc1, b>, <pc2, b>, etc.) which are read-write independent, may be discarded, and method 500 may proceed to block 526. For example, the persistent set and the visited set may be updated based on the process described above with reference to block 510.

At block 526, it may be determined whether an event sequence bound of the enabled event set has been reached. If the event sequence bound has been reached, method 500 may return to block 518. If the event sequence bound has not been reached, method 500 may proceed to block 528.

At block 528, a state from the event set may be randomly selected and set as the current state, and method 500 may proceed to block 530.

At block 530, the enabled event set may be found and an event may be randomly selected, and method may return to block 520.

Modifications, additions, or omissions may be made to method 500 without departing from the scope of the present disclosure. For example, the operations of method 500 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIG. 6 is a block diagram of an example computing device 600, in accordance with at least one embodiment of the present disclosure. Computing device 600 may include a desktop computer, a laptop computer, a server computer, a tablet computer, an embedded computer, a mobile phone, a smartphone, a personal digital assistant (PDA), an e-reader device, a network switch, a network router, a network hub, other networking devices, or other suitable computing device.

Computing device 600 may include a processor 610, a storage device 620, a memory 630, and a communication device 640. Processor 610, storage device 620, memory 630, and/or communication device 640 may all be communicatively coupled such that each of the components may communicate with the other components. Computing device 600 may perform any of the operations described in the present disclosure.

In general, processor 610 may include any suitable special-purpose or general-purpose computer, computing entity, or processing device including various computer hardware or software modules and may be configured to execute instructions stored on any applicable computer-readable storage media. For example, processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 6, processor 610 may include any number of processors configured to perform, individually or collectively, any number of operations described in the present disclosure.

In some embodiments, processor 610 may interpret and/or execute program instructions and/or process data stored in storage device 620, memory 630, or storage device 620 and memory 630. In some embodiments, processor 610 may fetch program instructions from storage device 620 and load the program instructions in memory 630. After the program instructions are loaded into memory 630, processor 610 may execute the program instructions.

For example, in some embodiments one or more of the processing operations for analysis of an event driven application may be included in data storage 620 as program instructions. Processor 610 may fetch the program instructions of one or more of the processing operations and may load the program instructions of the processing operations in memory 630. After the program instructions of the processing operations are loaded into memory 630, processor 610 may execute the program instructions such that computing device 600 may implement the operations associated with the processing operations as directed by the program instructions.

Storage device 620 and memory 630 may include computer-readable storage media for carrying or having computer-executable instructions or data structures stored thereon. Such computer-readable storage media may include any available media that may be accessed by a general-purpose or special-purpose computer, such as processor 610. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 610 to perform a certain operation or group of operations.

In some embodiments, storage device 620 and/or memory 630 may store data associated with event driven application analysis.

Communication device 640 may include any device, system, component, or collection of components configured to allow or facilitate communication between computing device 600 and another device. For example, communication device 640 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. Communication device 640 may permit data to be exchanged with any network such as a cellular network, a Wi-Fi network, a MAN, an optical network, etc., to name a few examples, and/or any other devices described in the present disclosure, including remote devices.

In some embodiments, communication device 640 may provide for communication within a network. Communication device 640 may include one or more interfaces. In some embodiments, communication device 640 may include logical distinctions on a single physical component, for example, multiple interfaces across a single physical cable or optical signal.

Modifications, additions, or omissions may be made to FIG. 6 without departing from the scope of the present disclosure. For example, computing device 600 may include more or fewer elements than those illustrated and described in the present disclosure. For example, computing device 600 may include an integrated display device such as a screen of a tablet or mobile phone or may include an external monitor, a projector, a television, or other suitable display device that may be separate from and communicatively coupled to computing device 600.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

As used herein, the term “data” in plural form may also include the singular form “datum” (e.g., countable noun). Stated another way, for example, the term “data” as used herein may comprise a countable or uncountable noun.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A device, comprising:
one or more processors configured to:
execute, in a symbolic environment, an event of an enabled event set;
update a persistent set and a visited event of the event set via symbolic dynamic partial order reduction; and
discard each path constraint and event pair being read-write independent.

2. The device of claim 1, wherein the one or more processors are further configured to randomly select the event for symbolic execution.

3. The device of claim 1, wherein the one or more processors are further configured to determine if a bound of an event sequence of the enabled event set has been reached.

4. The device of claim 3, wherein the one or more processors are further configured to generate an initial event sequence if the bound of the enabled event set has been reached.

5. The device of claim 4, wherein the one or more processors are further configured to identify an unexplored event in the event sequence.

6. The device of claim 5, wherein the one or more processors are further configured to execute the unexplored event via symbolic execution.

7. The device of claim 1, wherein the one or more processors are further configured to iterate each state in the enable event set to update the persistent set and the visited event of the enabled event set via symbolic dynamic partial order reduction.

8. A non-transitory computer-readable media having computer instructions stored thereon that are executable by a processing device to perform or control performance of operations comprising:
executing, in a symbolic environment, an event of an enabled event set;
updating a persistent set and a visited event of the enabled event set via symbolic dynamic partial order reduction; and
discarding each path constraint and event pair being read-write independent.

9. The computer-readable media of claim 8, the operations further comprising randomly selecting the event for symbolic execution.

10. The computer-readable media of claim 8, the operations further comprising determining if a bound of the enabled event state has been reached.

11. The computer-readable media of claim 10, the operations further comprising generating an event sequence if the bound of the enabled event state has been reached.

12. The computer-readable media of claim 11, the operations further comprising identifying an unexplored event in the event sequence.

13. The computer-readable media of claim 12, the operations further comprising executing the unexplored event via symbolic execution.

14. The computer-readable media of claim 8, the operations further comprising iterating each state in the enabled event set to update the persistent set and the visited event of the enabled event set via symbolic dynamic partial order reduction.

15. A method of analyzing an event driven application, comprising:
executing, in a symbolic environment, an event of an enabled event set;
updating a persistent set and a visited event of the enabled event set via symbolic dynamic partial order reduction; and
discarding each path constraint and event pair being read-write independent.

16. The method of claim 15, further comprising iterating each state in the enabled event set to update the persistent set and the visited event of the enabled event set via symbolic dynamic partial order reduction.

17. The method of claim 15, further comprising determining if a bound of an event sequence of the enabled event set has been reached.

18. The method of claim 17, further comprising generating an initial event sequence if the bound of the enabled event set has been reached.

19. The method of claim 18, further comprising identifying an unexplored event in the event sequence.

20. The method of claim 19, further comprising executing the unexplored event via symbolic execution.
